(19) United States
(12) Patent Application Publication
(10) Pub. No.: US 2026/0066284 A1
(43) Pub. Date: Mar. 5, 2026

(54) ELECTRODE PRECURSOR COMPOSITION

(71) Applicant: Dyson Technology Limited, Malmesbury, Wiltshire (GB)

(72) Inventors: Matthew Robert ROBERTS, Oxford (GB); Liyu JIN, Swindon (GB); Daniel Stephen MACPHERSON, Trowbridge (GB); Reza PAKZAD, Swindon (GB); Alex MADSEN, Swindon (GB)

(21) Appl. No.: 19/108,337

(22) PCT Filed: Sep. 11, 2023
(86) PCT No.: PCT/IB2023/058998

§ 371 Date: Mar. 3, 2025

(30) Foreign Application Priority Data
Sep. 15, 2022 (GB) 2213544.6

(51) Int. Cl. H01M 4/485; H01M 4/02; H01M 4/1391; H01M 4/1399; H01M 4/62; H01M 10/052; H01M 10/054

(52) U.S. Cl. CPC H01M 4/485; H01M 4/1391; H01M 4/1399; H01M 4/625; H01M 4/628; H01M 10/052; H01M 10/054; H01M 2004/023; H01M 2004/028

(57) ABSTRACT

Disclosed is an electrode precursor composition suitable for preparing a gel electrode, the composition containing an organic solvent, an alkali metal salt, and two or more polymers, the two or more polymers including at least an electronically insulating polymer and an electronically conductive polymer, wherein the electronically conductive polymer is present in a smaller volume fraction than the electronically insulating polymer.

### FIELD OF THE INVENTION

The present invention relates to an electrode precursor composition for an alkali metal ion secondary cell. The invention also relates to electrodes, cells and energy storage devices made from such precursor compositions, along with methods of preparing electrodes for alkali metal ion secondary cells.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells.

Traditional lithium ion battery components such as electrodes are made from a solvent cast process that uses sacrificial solvent. This is an energetically expensive step, and a process that avoids using sacrificial solvent is therefore desirable.

One approach to avoiding the use of sacrificial solvent is preparing gel electrodes. These electrodes can be formed from a composition prepared by mixing the necessary components such as electrochemically active material, polymer (typically an electronically insulating polymer), and a solvent or liquid electrolyte, and subsequently subjecting the composition to a processing treatment such as extrusion, to form the electrode.

The use of a gel in the preparation of an electrode using such processing treatments must balance at least two opposing requirements. On the one hand, the electrode must have sufficiently high electronic conductivity to be of practical use. For this, a higher solids content (higher content of electrochemically active material) is typically desirable to provide the material with a useful electronic conductivity. On the other hand, the gel must be sufficiently soft to be processed to form the electrode. For this, a lower solids content (lower content of electrochemically active material) is desirable, so that the material behaves sufficiently fluidly to be processable.

There is a need for electrode precursor compositions which satisfy the above criteria.

### SUMMARY OF THE INVENTION

In general, the present inventors propose to address the above problems by making use of electronically conducting polymers as a fraction of the electrode precursor composition. In particular, the inventors generally propose to replace a portion of the usual electronically insulating polymer with electronically conducting polymer. Typically, the electronically insulating polymer is considered to have some structural function and is typically swellable. In the present invention, the volume fraction of the electronically conductive polymer should be smaller than the volume fraction of the electronically insulating polymer.

In this way, the inventors believe it is possible to increase the electronic conductivity of a gel electrode compared to a corresponding gel electrode without the electronically conducting polymer. For example, if the electrode precursor composition requires a reduced amount of electrochemically active material for processability, then the presence of an electronically conducting polymer can at least partially compensate for the expected corresponding reduction in electronic conductivity. Similarly, if the electrode precursor composition does not require a reduced amount of electrochemically active material for processability, then the use of an electronically conducting polymer can add capacity and result in an electrode with higher electronic conductivity than expected for a gel electrode without the electronically conducting polymer. The present invention is based on this finding.

Use of electronically conductive polymers in electrodes are known, as discussed by e.g. Poizot et al. (Chem. Rev. 2020, 120, 14, 6490-6557). For example, Duc et al. (ACS Appl. Polym. Mater. 2020, 2, 6, 2366-2379) discloses a long-range electronic conductor based on PEO and PEDOT:PSS. The authors report that extrusion of these blends introduced phase segregation phenomena requiring an acidic post-treatment to restore electronic conductivities. U.S. Pat. No. 9,722,249 B2 and DE 102012022976 A1 disclose compositions comprising complexes of polythiophene and polyanions, at least one lithium-containing compound, and at least one solvent, wherein the composition comprises less than 1 g of a material comprising elemental carbon, based on 1 g of the polythiophenes, or comprises no material at all comprising elemental carbon. JP 2004-158286 A discloses electrodes containing PEDOT and PVDF as binder produced by molding. JP 2011-100594 A discloses a composition comprising a conductive polymer, formed by polymerizing ethylenedioxy thiophene or a derivative in the presence of at least one kind of polymeric sulfonic acid selected from the group consisting of polystyrene sulfonic acid, sulfonated polyester, and phenolsulfonic acid novolak resin, containing the polymeric sulfonic acid as a dopant, and an organic solvent and a carbonaceous conductive material, as well as an electrode mixture composition which also includes a binder an electrode active material.

However, these documents do not describe the concept of increasing the electronic conductivity of gel electrodes by using electronically conductive polymer which is present in a composition in a smaller volume fraction than the electronically insulating polymer. The present inventors are using the electronically conducting polymer to generate high electronic conduction through the whole of the media used to prepare the gel electrodes, and in such a way that the electrode can be directly prepared from the electrode precursor composition.

Accordingly, a general proposal of the present invention is to provide a processable gel electrode precursor composition containing an electronically conducting polymer, an electronically insulating polymer, an alkali metal salt, and an organic solvent. This composition may be subsequently combined with electrochemically active material and a conductive additive, before being further processed to form an electrode. Using this general procedure, the inventors find that the electrode precursor composition is highly processable while also forming an electrode with sufficient electronic conductivity for practical use. The electronically insulating polymer and electronically conductive polymers may provide sufficient conductivity for the electrode and, in such cases, it may advantageously be possible to use a reduced amount of conductive carbon-based additive. Accordingly, the loading of electrochemically active material can be increased with the same degree of processability.

A first aspect of the invention concerns an electrode precursor composition suitable for preparing a gel electrode, the composition comprising an organic solvent, an alkali metal salt, and two or more polymers, the two or more polymers including at least an electronically insulating polymer and an electronically conductive polymer, wherein the electronically conductive polymer is present in a smaller volume fraction than the electronically insulating polymer.

The resulting electrode precursor composition typically contains a polymeric gel matrix phase. In this way, the electrode precursor composition typically has a gel-like quality and can be processed into a thin-film electrode.

According to a second aspect, the present invention concerns a method of preparing an electrode for an alkali metal ion secondary cell, the method comprising
a providing step, comprising providing an electrode precursor composition according to the first aspect; and
a processing step, comprising processing the electrode precursor composition to form an electrode.

Further aspects concern an electrode for an alkali metal ion secondary cell prepared from an electrode precursor composition or method according to the present invention, an electrochemical secondary cell, such as an alkali metal ion secondary cell, comprising an electrode according to the present invention, an electrochemical energy storage device comprising an electrochemical cell according to the present invention, and use of an electronically conductive polymer in a method of preparing an electrode for an alkali metal ion secondary cell using a high temperature processing step.

### BRIEF DESCRIPTION OF THE DRAWINGS

FIG. 1 is a schematic diagram of theoretical electrodes having (a),(b) close to ideal packing of electrochemically active material and (c),(d) non-ideal packing of electrochemically active material.

### DETAILED DESCRIPTION AND PREFERRED EMBODIMENTS

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

Unless otherwise defined, all technical and scientific terms used herein have the same meaning as commonly understood by one of ordinary skill in the art to which this disclosure belongs. Methods and materials are described herein for use in the present disclosure; other, suitable methods and materials known in the art can also be used. The materials, methods, and examples are illustrative only and not intended to be limiting. All publications, patent applications, patents, and other references mentioned herein are incorporated by reference in their entirety. In case of conflict, the present specification, including definitions, will control.

Methods described herein usually employ ambient temperature of a typical laboratory, which is typically between 2° and 30° C. and preferably around 25° C., at atmospheric pressure, unless a different condition is defined herein or is more usually employed e.g. for a particular apparatus.

The present invention generally describes the use of electronically conducting polymers in electrode precursor compositions, and such electrode precursor compositions are particularly suitably used to prepare electrodes using a processing step which comprises one or more of extrusion and thermal processing. The electronically conducting polymers, also known as intrinsically conducting polymers, are organic polymers that conduct electricity. Typically, these polymers have conjugated double bonds which allow the flow of electrons across the polymer backbone. Depending on the nature of the electronically conducting polymer, a dopant may be used to achieve practically useful electrical conductivities.

Useful electrical conductivities of electronically conducting polymers for the present invention are at least 0.01 S/cm, and preferably higher such as at least 0.1 S/cm, at least 0.5 S/cm, at least 1.0 S/cm or at least 2 S/cm.

Electrical conductivity testers are available and can be used to measure the electrical conductivities of the electronically conducting polymers used in the present invention. An exemplary method of measuring the electrical conductivity involves applying a sample to a substrate and using a conductivity probe attached to a conductivity tester. During operation, the conductivity tester will apply a small current across pins on the conductivity probe and calculate a resistive correction factor based on parameters input by the user. An example of a suitable conductivity tester is a Loresta-GP MCP-T610.

It will be understood that the electronically conductive polymer should be present in the electrode precursor composition in an amount which is sufficient to achieve the desired amount of increase in electronic conductivity. Accordingly, in some embodiments, the electronically conductive polymer is present in the electrode precursor composition in an amount of at least 1 vol %, based on the total volume of the electrode precursor composition, for example at least 2 vol %, at least 3 vol %, or at least 5 vol %.

Furthermore, the electronically conducting polymer is present in the electrode precursor composition in a smaller volume fraction than the electronically insulating polymer.

Accordingly, in some embodiments, the electronically conductive polymer is present in the electrode precursor composition in an amount of up to 20 vol %, based on the total volume of the electrode precursor composition, for example up to 18 vol %, up to 15 vol %, up to 10 vol %, or up to 8 vol %.

Accordingly, in some embodiments, the electronically conductive polymer is present in the electrode precursor composition in an amount of between 1 to 20 vol %, based on the total volume of the electrode precursor composition. Other combinations of the above values may be combined to form a suitable range, such as between 2 to 18 vol %, between 2 to 10 vol %, or between 5 to 8 vol %.

It is noted that the total vol % of all ingredients in the electrode precursor composition is 100 vol %.

In a particularly advantageous embodiment, the electronically conductive polymer is also redox active. Redox active polymers are polymers which can undergo reversible oxidation and reduction processes. Accordingly, they represent a particularly useful sub-class of electronically conducting polymers because they have the additional ability to store charge.

By using redox active polymers, the inventors consider it is possible to increase the energy density of an electrode compared to a corresponding electrode without the redox active polymer. For example, if the electrode precursor composition requires a reduced amount of electrochemically active material for processability, then the presence of a redox active polymer can at least partially compensate for the expected corresponding reduction in energy density. Similarly, if the electrode precursor composition does not require a reduced amount of electrochemically active material for processability, then the use of a redox active polymer can add capacity and result in an electrode with higher energy density than expected for an electrode without the redox active polymer.

In this way, the use of a conductive and redox-active polymer achieves both compensation or improvement of energy density of an electrode as well as improving processability simultaneously.

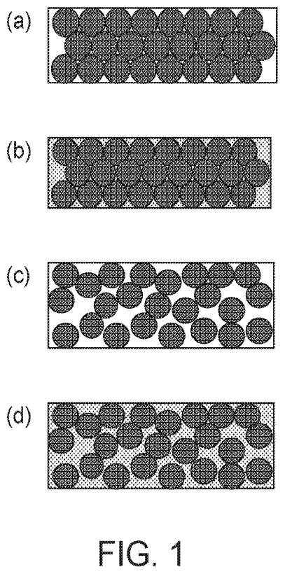

This principle is shown in FIG. 1, in which (a) shows a close to ideal electrode with near-perfect packing of electrochemically active particles.

Theoretically, this has a >73% solids packing (close to ideal) with ˜68% volume electrochemically active material (black circles) and the intervening space filled with gel (white). This can result in an active material capacity of around 210 mAhg⁻¹, and an electrode capacity of around 183 mAhg⁻¹. The same electrode as (a) is shown in (b) but with a redox active conductive polymer (grey) included in the gel in the pores, which may be represented e.g. by PEDOT. While the other values remain the same, the electrode capacity may be increased to 186 mAhg⁻¹.

A similar trend can be seen for a lower packing efficiency scenario. FIG. 1(c) shows a non-ideal electrode, such as of the kind which may more typically be achieved through an extrusion process. This electrode has an imperfect packing of <73% solids packing and ˜63% volume of electrochemically active particles (black circles) and the intervening space filled with gel (white). This can result in an active material capacity of around 210 mAhg⁻¹, and electrode capacity of 177 mAhg⁻¹. The same electrode as (c) is shown in (d) but with a redox active conductive polymer such as PEDOT (grey) in the pores. While the other values remain the same, the electrode capacity may be increased to 181 mAhg⁻¹. Thus, it can be seen that replacing some of the gel polymer with a redox active polymer can compensate somewhat for loss of volumetric capacities and provide increased electronic conductivity. Thus, higher energies may be achieved. This is particularly important for the non-ideal example, since this already has lower energy density and represents a greater challenge to ensure long range electronic conductivity.

In each of (a) to (d), the other components such as conductive additive and electronically insulating polymer are not shown.

In cathodes, the charge is stored through anionic insertion. That is, the compensation of energy density is achieved by an anionic doping reaction. The skilled person will be familiar with electrochemical storage mechanisms using redox-active organics; in this regard we further refer to FIG. 9 and Table 1 of Poizot et al. (Chem. Rev. 2020, 120, 14, 6490-6557). FIG. 9a of Poizot et al. shows an example of anionic compensation of a p-type system in which a polymer (shown as

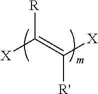

and comprising a conjugated double bond can be reversibly doped with anion A⁻. This process is shown for a two-fold reversible doping step (n=2). Each doping step involves loss of one electron from the polymer.

Accordingly, in embodiments using a redox active polymer which undergoes an anionic doping reaction, the gel electrode can comprise up to 8 vol % of the redox active polymer, such as up to 7 vol %, up to 6 vol % or up to 5 vol % of the redox active polymer, to avoid effective depletion of anions and thus maintain cell performance.

Many electronically conducting polymers, and polymers which are both electronically conducting and redox active, will be known to the skilled person. Indeed, several electronically conducting polymers are also redox active. Such electronically conducting and optionally redox active polymers may be used in the present invention alone or in combination. Purely by way of example and not limitation, electronically conductive polymers suitable for use in the invention include one or more of thiophene containing polymers such as polythiophene and poly(3,4-theylenedioxythiophene) (PEDOT); aniline containing polymers such as polyaniline (PANI); pyrrole containing polymers such as polypyrrole (PPy); acetylene containing polymers such as polyacetylene; organosulfur polymers, including organodisulfide polymers, such as 2,5-dimercapto-1,3,4-thiadiazole, poly(2,2′-dithiodianiline), sulfur-polyacrylonitrile, poly(sulfur-random-1,3-diisopropenylbenzene) (poly(S-r-DIB)); amine containing polymers such as poly(2,2,6,6-tetramethylpiperidinyloxy-4-yl methacrylate (PTMA) and triphenylamine containing polymers such as polytriphenylamine (PTPA), poly(3-vinyl-N-methylphenothiazine (PVMPT); quinone containing polymers such as polydopamine, calix[4]quinone, pillar[5]quinone, poly(benzoquinonyl sulfide) (PBQS) and poly(2,5-dihydro-p-benzoquinonyl sulfide) (PDBS); anthraquinone containing polymers such as P14AQ and lithium derivatives thereof such as Li₂PDBS and poly-LiDHAQS, poly(benzo[1,2-b:4,5-b′]-dithiophene-4,8-dione-2,6-diyl) (PBDTD); imide containing polymers such as poly{[N,N′-bis(2-octlydodecyl)-1,4,5,8-naphthalenedicarboximide-2,6-diyl]-alt-5,5′-(2,2′-bithiophene)}(P(ND120D-T2)) and poly(ethylene-pyromellitic diimide) (PPDIE); and poly(4-glycidyloxy-2,2,6,6-tetramethylpiperidine-1-oxyl) (PTEO).

Also suitable for the present invention are electronically conductive polymers which are doped derivatives of any of these electronically conductive polymers, such as poly(3,4-theylenedioxythiophene)-polystyrene sulfonate (PEDOT-PSS).

In some embodiments, the electronically conductive polymer includes one or more of polythiophene, PEDOT; PANI; PPy; polyacetylene; PTPA, polydopamine, PBQS, PDBS; and PEDOT-PSS. In some embodiments, the electronically conductive polymer includes one or more of polythiophene, PEDOT; PANI; PPy; and PEDOT-PSS.

The electrode precursor composition of the present invention also comprises an electronically insulating polymer. These polymers are not intrinsically conducting polymers, and do not conduct electricity or conduct electricity to a negligible degree.

Typically, these polymers are substantially free of conjugated double bonds which allow the flow of electrons across the polymer backbone.

The electronically insulating polymer(s) for use in the present electrode precursor compositions are polymers typically used in the preparation of gel electrodes. They are generally swellable. They may be used in the present invention alone or in combination.

Many will be known to the skilled person. Purely by way of example and not limitation, electronically insulating polymers suitable for use in the present invention include one or more of polyvinylidene fluoride (PVDF), polyethylene oxide (PEO), polymethylmethacrylate (PMMA) and polyacrylonitrile.

In some embodiments, the electronically insulating polymer is present in the electrode precursor composition in an amount of at least 5 vol %, based on the total volume of the electrode precursor composition, such as at least 7 vol %, at least 10 vol % or at least 15 vol %.

In some embodiments, the electronically insulating polymer is present in the electrode precursor composition in an amount of up to 30 vol %, based on the total volume of the electrode precursor composition, such as up to 28 vol %, up to 25 vol %, or up to 20 vol %.

Accordingly, in some embodiments, the electronically insulating polymer is present in the electrode precursor composition in an amount of between 5 to 30 vol %, based on the total volume of the electrode precursor composition. Other combinations of the above values may be combined to form a suitable range, such as between 5 to 28 vol %, between 7 to 25 vol %, or between 10 to 20 vol %.

The electrode precursor composition of the present invention comprises at least one alkali metal salt.

The alkali metal of the at least one alkali metal salt may be any suitable alkali metal (Group I of the periodic table). Typically, it may be lithium, sodium and potassium. In some embodiments, the alkali metal of the at least one alkali metal salt is lithium and this may be preferred in all embodiments of the invention.

The anion of the at least one alkali metal salt may be any suitable anion. Typical anions are known to the skilled person and may be chosen based on the nature of the alkali metal. In some embodiments, when the at least one alkali metal is lithium, the anion of the or each alkali metal salt is independently selected from: a lithium borate salt, a lithium imide salt, and a lithium imidazolide salt, or comprises a halogen such as fluorine. Examples include BF₄⁻, PF₆⁻, TFSI⁻, FSI⁻ and TDI⁻.

Accordingly, in some embodiments, the at least one alkali metal salt comprises one or more of lithium bis(oxalato)borate, lithium tetrafluoroborate, lithium difluoro(oxalate)borate (LiDFOB), lithium bis(trifluoromethanesulfonyl)imide (LiTFSI), lithium bis(fluorosulfonyl) imide (LiFSI), lithium 2-trifluoromethyl-4,5-dicyanoimidaxolide (LiTDI) and lithium hexafluorophosphate (LiPF₆).

In some embodiments, the at least one alkali metal salt comprises one or more of LiFSI, LiDFOB and LiTDI

In some particularly useful embodiments, the at least one alkali metal salt comprises one or more of LiBF₄, LiPF₆, LiTFSI, LiFSI and LiTDI.

One or more kinds of alkali metal salt may be used in accordance with the present invention. Typically, but not exclusively, when more than one kind of alkali metal salt is used, they share a common alkali metal cation. Typically, but not exclusively, when more than one salt is present, they are each a lithium salt.

The organic solvent used in the present invention is an organic solvent which is typically used in the manufacture of electrodes for alkali metal secondary cells. The organic solvent should suitably be capable of being blended with, e.g. to form a solution with the polymers of the electrode precursor composition.

In some embodiments, the organic solvent is non-aqueous. In some embodiments, the solvent comprises one or more cyclic or linear carbonate, ether or nitrile compounds. In some embodiments the solvent comprises one or more cyclic or linear carbonate compounds.

In some embodiments the one or more linear or cyclic carbonate compound comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone.

In some embodiments, the alkali metal salt and organic solvent together is present in an amount of at least 5 vol %, based on the total volume of the electrode precursor composition, such as at least 7 vol %, at least 10 vol % or at least 15 vol %.

In some embodiments, the alkali metal salt and organic solvent is present in an amount of up to 35 vol %, based on the total volume of the electrode precursor composition, such as up to 32 vol %, up to 30 vol % or up to 25 vol %.

Accordingly, in some embodiments, the alkali metal salt and organic solvent is present in an amount of between 5 to 35 vol %, based on the total volume of the electrode precursor composition. Other combinations of the above values may be combined to form a suitable range, such as between 7 to 32 vol %, between 10 to 30 vol %, or between 15 to 30 vol %.

The skilled person will be aware of a large number of possible electrochemically active materials, including cathode active materials (also called positive active materials) and anode active materials (also called negative active materials), which may be used in the present invention.

The electrochemically active material is a particulate material, i.e. a material made up of a plurality of discrete particles. The particles may comprise primary particles and/or secondary particles formed from the agglomeration of a plurality of primary particles.

In some embodiments, the electrochemically active material is a positive active material. That is, the electrode functions as a cathode.

In some embodiments, the positive active material is a lithium transition metal oxide material. In some embodiments, the positive active material is a lithium transition metal oxide material, or a lithium transition metal phosphate material, or a lithium transition metal sulfide material. These comprise, respectively, a mixed metal oxide, phosphate or sulfide of lithium and one or more transition metals, optionally further comprising one or more additional non-transition metals. In some embodiments, the positive active material is a lithium transition metal oxide, phosphate or sulfide material comprising lithium and one or more transition metals selected from nickel, cobalt and manganese. In some embodiments, the positive active material is a lithium transition metal oxide material comprising a mixed metal oxide of lithium and one or more transition metals, optionally further comprising one or more additional non-transition metals. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium.

Such electrochemically active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The electrochemically active materials may be undoped or uncoated or may contain one or more dopants and/or a coating. For example, the electrochemically active material may be doped with small amounts of one or more metal elements. The electrochemically active material may comprise a carbon coating on the surface of the particles of the material.

In some embodiments, the electrochemically active material is present in an amount of at least 55 vol %, based on the total volume of the electrode precursor composition, such as at least 56 vol %, at least 57 vol %, at least 58 vol %, at least 59 vol %, at least 60 vol %, at least 61 vol %, or at least 62 vol %.

In some embodiments, the electrochemically active material is present in an amount of up to 75 vol %, based on the total volume of the electrode precursor composition, such as up to 74 vol %, up to 73 vol %, up to 72 vol %, up to 71 vol %, up to 70 vol %, up to 69 vol % or up to 68 vol %.

In some embodiments the electrochemically active material is present in an amount of from 55 to 75 vol %, based on the total volume of the electrode precursor composition. Other combinations of the above values may be combined to form a suitable range, such as from 55 to 70 vol %, from 55 to 69 vol %, from 55 to 68 vol %, from 58 to 68 vol %, or from 60 to 68 vol %.

In some embodiments the electrochemically active material makes up from 62 to 75 vol % of the electrode precursor composition, for example from 62 to 70 vol %, from 62 to 69 vol %, from 62 to 68 vol % or from 62 to 69 vol %.

In some embodiments the electrochemically active material is present in an amount of between 62 to 75 vol % of the electrode precursor composition, such as from 60 to 75 vol %, from 60 to 72 vol %, from 60 to 70 vol % or from 60 to 68 vol %.

In some embodiments, the electrode precursor composition further comprises a conductive additive, preferably which includes a conductive carbon. The conductive additive may be particulate.

In some embodiments, the conductive additive comprises or consists of one or more of carbon black, carbon nanotubes, graphene and graphite. In some embodiments, the conductive additive comprises or consists of carbon black or graphite, preferably carbon black. Examples of commercially available carbon black include Ketjen Black and Super C65.

In some embodiments, the conductive additive is present in an amount of at least 1 vol %, based on the total volume of the precursor composition, such as at least 2 vol %, at least 3 vol %, or at least 4 vol %.

In some embodiments, the conductive additive is present in an amount of up to 10 vol %, based on the total volume of the electrode precursor composition, such as up to 9 vol %, up to 8 vol %, or up to 7 vol %.

Accordingly, in some embodiments, the conductive additive is present in an amount of between 1 to 10 vol %, based on the total volume of the electrode precursor composition. Other combinations of the above values may be combined to form a suitable range, such as between 1 to 9 vol %, between 1 to 8 vol %, between 2 to 8 vol % or between 3 to 7 vol %.

In embodiments where a composition contains electronically conductive polymer (in an amount of q vol %), electronically insulating polymer (in an amount of z vol %), alkali metal salt, organic solvent and electrochemically active material (together in an amount totalling×vol %), and conductive additive (in an amount of y vol %), then x+y+z+q=100 vol %.

In some such embodiments, typically (x+y)>(q+z).

In some such embodiments, q/(q+z) is typically at least 0.25, such as at least 0.27 or at least 0.30. In further examples, q/(q+z) may be at least 0.32, at least 0.35 or at least 0.40. In some such embodiments, q/(q+z) is typically less than 0.5, such as up to 0.49, up to 0.47, up to 0.45 or up to 0.40. Accordingly, in some such embodiments, when x+y>70 vol % then q/(q+z) is typically between 0.25 and less than 0.50. Other combinations of the above values may be combined to form a suitable range, such as between 0.27 and less than 0.50, between 0.27 and 0.49, or between 0.30 and 0.45.

Also provided herein is a method of making an electrode precursor composition as described herein. In general, the method comprises blending the electronically conductive polymer, the electronically insulating polymer, the alkali metal salt, and the organic solvent. Typically, this blend will form a gel. Without wishing to be bound by theory, it is considered that cooling provides the gel with sufficient mechanical strength. The ingredients can be blended simultaneously or in any appropriate order, for any suitable time, in any suitable way. For example, the appropriate amounts of each may be simultaneously added and mixed.

Subsequently, the blend of organic solvent, alkali metal salt, electronically insulating polymer, and electronically conductive polymer, is combined with the electrochemically active material and the conductive additive, and optionally any further components. The electrochemically active material and the conductive additive can be combined with the blend simultaneously or in any appropriate order, for any suitable time, in any suitable way.

Typically the components will be mixed together using a variety of standard mixing equipment such as planetary mixing to ensure a good dispersion of components. The mixture will then be passed through a twin-screw extruder at elevated temperatures (>110° C.) which will may combine the polymers and liquids into a viscous gel. Alternatively, the components maybe fed individually into the extruder via individual feeders and the mixing occurs inside the extruder. The material can then either be extruded directly through a die head into a thin sheet or can be extruded roughly before being calendared into a film. This film can then be adhered to a metal foil which can be assembled into a battery.

Any suitable equipment for preparing electrode precursor compositions may be used to prepare the electrode precursor compositions herein, for example standard mixing equipment.

The electrode precursor composition may subsequently be processed into an electrode as described herein.

Also provided herein is a method of preparing an electrode for an alkali metal ion secondary cell. In general, the method includes a providing step, comprising providing an electrode precursor composition as described herein, and a processing step, comprising processing the electrode precursor composition to form an electrode. Thus, it will be understood that electrode precursor compositions as described herein are used for preparing electrodes according to the invention. Accordingly, steps described elsewhere herein for preparing the electrode precursor compositions apply equally to the providing step of the method of preparing an electrode.

In some embodiments, the processing step comprises one or more of extrusion and thermal processing.

In some embodiments, the processing step comprises at least thermal processing. That is, the processing step comprises a step of applying high temperature in a fluid state formation process.

In some embodiments the thermal processing comprises passing the electrode precursor composition through a roller assembly at a temperature of at least 50° C., for example at least 60° C., at least 70° C., at least 80° C., at least 90° C. or at least 100° C.

In some embodiments the thermal processing comprises passing the electrode precursor composition through rollers at a temperature of up to 150° C., for example up to 140° C. or up to 130° C. In some embodiments the thermal processing comprises passing the electrode precursor composition through rollers at a temperature of from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

The roller assembly may comprise two rollers separated by a small distance such that the electrode precursor composition is pressed into a thin film when passed through the rollers.

In some embodiments the processing step comprises at least extruding the electrode, or extrusion. In some embodiments the processing step comprises extruding the electrode using an extrusion apparatus comprising one or more screw feeding sections and an extrusion die. In some embodiments, extrusion is achieved using a twin screw extruder.

In some embodiments in which both extrusion and thermal processing are used in the processing step, the temperature of the die is at least 50° C., for example at least 60° C., at least 70° C., at least 80° C., at least 90° C. or at least 100° C. In some embodiments the temperature of the die is up to 150° C., for example up to 140° C. or up to 130° C. In some embodiments the temperature of the die is from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

In some embodiments the electrode has a thickness of less than 150 μm, for example less than 100 μm, less than 90 μm, less than 80 μm or less than 70 μm. In some embodiments the electrode has a thickness of from 40 to 150 μm, for example from 40 to 100 μm, from 40 to 90 μm, from 40 to 80 μm, from 40 to 70 μm or from 50 to 70 μm. In particular embodiments, the electrode has a thickness of from 40 to 100 μm.

In some embodiments the electrode has a thickness of from 40 to 150 μm, for example from 40 to 100 μm, from 40 to 90 μm, from 40 to 80 μm, from 40 to 70 μm or from 50 to 70 μm, and comprises the electrochemically active material in an amount of from 60 to 75 vol % of the electrode precursor composition, for example from 60 to 70 vol %, from 60 to 69 vol %, from 60 to 68 vol % or from 62 to 69 vol %.

In some cases, the extruded electrode may form part of an extruded monolith which includes one or more further layers which are present in an electrochemical battery. For instance, the monolith may include a separator layer, and/or may include the other electrode (i.e. the extruded monolith may include both a cathode and anode). The different layers may be coextruded and have different compositions from one another.

In some embodiments, the method of the invention further comprises shaping and/or cutting the electrode to form an electrode of predetermined dimensions.

In some embodiments, the electrode film has a thickness of from 500 to 700 μm. In some embodiments, the method of the invention further comprises performing a second thermal processing step on a cut film to reduce the thickness of the film to within a range of 50 to 70 μm.

In some embodiments, the temperature during that thermal processing step is from 100 to 140° C.

Also provided herein as an aspect of the invention is an electrode prepared by a method of the invention or from an electrode precursor composition of the invention. Typically, the electrode which results from the method of the invention is a gel electrode.

In some embodiments, the electrode which is prepared by the method of the invention has less than 10% porosity, such as less than 8% porosity, less than 5% porosity, less than 3% porosity or less than 1% porosity. In some embodiments, the electrode which is prepared by the method of the invention has 0% porosity.

The electrode porosity may be determined for example by comparison of theoretical density with observed density. That is, a skilled person can calculate the theoretical density of the electrode, and then measure the actual electrode density, using suitable means. Subsequently, the actual density is subtracted from the theoretical density to provide the porosity.

Without wishing to be bound by theory, the inventors consider that a lower porosity is generally advantageous because it reduces the tortuosity for the ions (e.g. lithium ions) to move through the gel of the electrode. Thus, the initial rate capability of the electrode is expected to be higher compared with an electrode having higher porosity. For similar reasons, it is expected that the electronic conductivity might be impacted in a similar way. Thus, the inventors expect the energy density is related to the porosity.

Also provided as an aspect of the invention is an electrochemical secondary cell comprising such electrode. The cell may be an alkali metal ion secondary cell, for example a sodium-ion secondary cell or a lithium-ion secondary cell. In some embodiments, the cell is a lithium-ion secondary cell.

In some embodiments the electrochemical secondary cell comprises a first electrode according to the invention, wherein the first electrode is a cathode, and an anode. In some embodiments, the electrochemical secondary cell comprises a second electrode according to the invention, wherein the second electrode is an anode, and a cathode. In some embodiments, the electrochemical secondary cell comprises a first and a second electrode according to the invention, wherein the first electrode is a cathode, and the second electrode is an anode. In each of these embodiments, the electrochemical secondary cell also comprises an electrolyte between the cathode and the anode. In some embodiments, the electrolyte is a liquid electrolyte. In some embodiments, the liquid electrolyte comprises or is a solution comprising an alkali metal salt as described herein.

In some embodiments the electrochemical secondary cell comprises an electrode according to the invention laminated with a current collector, for example a metallic foil.

Also provided herein as an aspect of the invention is an electrochemical energy storage device comprising an electrochemical secondary cell of the invention. In some embodiments, the electrochemical energy storage device is a battery. In some embodiments, the electrochemical energy storage device is a lithium-ion battery.

Also provided herein as an aspect of the invention is the use of an electronically conductive polymer in a method of preparing an electrode for an alkali metal ion secondary cell using at least one of a thermal processing step or an extrusion step. The electronically conductive polymer of this aspect is preferably an electronically conductive polymer as described herein for use in the first aspect. The method of preparing an electrode of this aspect is preferably a method of the second aspect as described herein.

In some embodiments, such use provides the electrode with an increased electrical conductivity compared to a corresponding electrode without the electronically conductive polymer. In some embodiments, such use provides the electrode with an increased energy density compared to a corresponding electrode without the electronically conductive, redox active polymer.

### EXAMPLES

The following is an exemplary electrode precursor composition for use in the present invention:

| | | Preferred | Specific | Specific |
|---|---|---|---|---|
| | Vol % of | vol % of | Example | Example |
| Ingredient | Composition | composition | 1 | 2 |
| Electronically conductive | 1-20 | 1-20 | 5 | 7 |
| polymer (e.g. one or more of | | | | |
| PEDOT, PANI, PPy, or | | | | |
| PEDOT-PSS) | | | | |
| Electronically insulating | 5-30 | 5-30 | 7 | 10 |
| polymer (e.g. one or more of | | | | |
| PVDF, PEO or PAN) | | | | |
| Alkali metal salt (e.g. one or | 1-50 | 1-40 of which | 15 | 18 |
| more of LiFSI, LiTFSI, or | | 1-50% is | | |
| LiBF₄); and | | alkali metal | | |
| organic solvent (e.g. one or | | salt and 50- | | |
| more of ethylene carbonate, | | 99% is | | |
| propylene carbonate, | | organic | | |
| vinylidene carbonate, | | solvent | | |
| fluoroethylene carbonate, and | | | | |
| γ-butyrolactone) | | | | |
| Electrochemically active | up to 75 | Greater than | 68% | 64 |
| material (e.g. one or more of | | 50% but less | | |
| LiCoO₂, NMC, or LiMn₂O₄) | | than 75% | | |
| Conductive carbon | 1-10 | 1-7 | 5 | 1 |

1. An electrode precursor composition suitable for preparing a gel electrode, the composition comprising an organic solvent, an alkali metal salt, and two or more polymers,
the two or more polymers comprising at least an electronically insulating polymer and an electronically conductive polymer, wherein the electronically conductive polymer is present in a smaller volume fraction than the electronically insulating polymer.

2. The electrode precursor composition according to claim 1, wherein the electronically conductive polymer is present in the electrode precursor composition in an amount of between 1 to 20 vol %, based on the total volume of the electrode precursor composition.

3. The electrode precursor composition according to claim 1, wherein the electronically conductive polymer is present in the electrode precursor composition in an amount of up to a maximum of 8 vol %, based on the total volume of the electrode precursor composition.

4. The electrode precursor composition according to claim 1, wherein the electronically conductive polymer is also redox active.

5. The electrode precursor composition according to claim 1, wherein the electronically conductive polymer comprises one or more selected from poly(3,4-etheylenedioxythiophene), polyaniline, polypyrrole, or doped derivatives thereof.

6. The electrode precursor composition according to claim 1, wherein the electronically insulating polymer comprises one or more selected from polyvinylidene fluoride, polyethylene oxide, polymethylmethacrylate or polyacrylonitrile.

7. The electrode precursor composition according to claim 1, wherein the electronically insulating polymer is present in the electrode precursor composition in an amount of between 5 to 30 vol %, based on the total volume of the electrode precursor composition.

8. The electrode precursor composition according to claim 1, wherein the alkali metal salt comprises a lithium salt.

9. The electrode precursor composition according to claim 8, wherein the lithium salt comprises one or more of LiBF₄, LiPF₆, LiTFSI, LiFSI or LiTDI.

10. The electrode precursor composition according to claim 1, wherein the organic solvent comprises one or more of a carbonate, an ether, or a nitrile.

11. The electrode precursor composition according to claim 1, further comprising an electrochemically active material.

12. The electrode precursor composition according to claim 11, wherein the electrochemically active material comprises a positive active material.

13. The electrode precursor composition according to claim 11, wherein the electrochemically active material is present in the electrode precursor composition in an amount of at least 60 vol %, based on the total volume of the electrode precursor composition.

14. The electrode precursor composition according to claim 1, further comprising an additive which includes a conductive carbon.

15. The electrode precursor composition according to claim 14, wherein the conductive carbon comprises one or more of carbon black, carbon nanotubes, graphene or graphite.

16. The electrode precursor composition according to claim 14, wherein the conductive carbon is present in the electrode precursor composition in an amount of between 1 to 10 vol %, based on the total volume of the electrode precursor composition.

17. A method of preparing an electrode for an alkali metal ion secondary cell, the method comprising
providing an electrode precursor composition according to claim 1, and
processing the electrode precursor composition to form an electrode.

18. The method according to claim 17, wherein the processing comprises one or more of extrusion and thermal processing.

19. The method according to claim 17, wherein the providing comprises providing an electrode precursor composition according to claim 1, and subsequently combining the electrode precursor composition with an electrochemically active material and conductive carbon.

20. The method according to claim 17, wherein the electrode is a gel electrode.

21. (canceled)

22. (canceled)

23. (canceled)

24. (canceled)
